(19) United States
(12) Patent Application Publication
(10) Pub. No.: US 2026/0363241 A1
(43) Pub. Date: Nov. 19, 2026

(54) Environmentally safe water-based solutions of the alkali metal salt tripotassium citrate (TPC) and their application or incorporation process for wood and wood products to prevent or reduce damage from termites.

(71) Applicant: Kenneth York, Los Angeles, CA (US)

(72) Inventor: Kenneth York, Los Angeles, CA (US)

(21) Appl. No.: 19/207,377

(22) Filed: May 14, 2025

(51) Int. Cl. A01N 37/36; A01N 25/02; A01N 59/14; A01P 7/04; C09D 5/14; C09D 5/16; C09D 7/40; C09D 7/41; C09D 7/45; C09D 7/61; C09D 7/63; C09D 7/65; C09D 15/00

(52) U.S. Cl. CPC A01N 37/36; A01N 25/02; A01N 59/14; A01P 7/04; C09D 5/14; C09D 5/1675; C09D 7/41; C09D 7/45; C09D 7/61; C09D 7/63; C09D 7/65; C09D 7/70; C09D 15/00

(57) ABSTRACT

Environmentally safe, water-based solutions of the alkali metal salt tripotassium citrate (TPC) that dry and form a crystalized coating have been developed and shown to be effective for the reduction and/or prevention of damage to wood and wood products from termites. The novel process of protecting wood and wood products from termites, with environmentally safe, water-based solutions of the alkali metal salt tripotassium citrate (TPC) by one or more surface applications or by incorporation during manufacturing of engineered wood products has been developed, tested, and shown to be effective.

Environmentally safe water-based solutions of the alkali metal salt tripotassium citrate (TPC) and their application or incorporation process for wood and wood products to prevent or reduce damage from termites.

### CROSS-REFERENCE TO RELATED APPLICATIONS

1. U.S. Pat. No. 6,416,789
2. U.S. Pat. No. 11,865,394
3. U.S. Pat. No. 11,697,639

### BACKGROUND

Tripotassium citrate (TPC) (K₃C₆H₅O₇) is a common chemical, often used in the food and beverage industry to regulate pH and prevent spoilage. It is used in medicine to prevent and treat kidney stones and it is an environmentally friendly flame retardant and fire extinguisher. It is used to increase the fire resistance of wood and brush and to slow the burning rate of cigarette paper. It has a high solubility in water of 1780 g/liter and a potassium content of 38.28%. It is biodegradable, non-toxic, and environmentally safe.

Traditional treatments to prevent or deter termite and other insect damage to wood include creosote, chromated copper arsenate, alkaline copper quaternary, copper naphthenate, and copper azole which are toxic and harmful to the environment.

Annual damage to homes in the U.S. from termites has been estimated at approximately seven billion dollars per year and it is typically not covered by insurance. A non-toxic method of termite protection would be very beneficial to the homeowner and the environment. TPC is generally considered environmentally friendly and non-toxic to humans and pets when contacted externally.

TPC interferes with the metabolic development and reproductive functions of wood destroying organism such as termites as well as slowing or preventing their spread. Potassium is a critical electrolyte and plays a vital role in nerve function by generating and transmitting electrical signals. Potassium ions maintain resting potentials, which are essential for action potentials and nerve impulses. Potassium ions are also essential for repolarization, preparing the nerve for the next nerve impulse. Potassium imbalance will disrupt nerve signal transmission and normal muscle function and can lead to termite death. Potassium imbalance can also adversely affect metabolic enzymes such as catalase, which reduces oxidation stress and promotes longevity in queen termites, thereby leading to colony collapse.

Termites have small but complex brains (cerebral ganglions) controlling their behavior and nerve cords in the thorax and abdomen. They have suboesophageal ganglions and mandibular nerves which control the mandibles that are essential for their defense and survival and sensory nerves that provide information on food sources and detect pheromones. Pheromones regulate the caste system and control work in the termite colony and any disruption of the caste system will cause the colony to fail. Potassium imbalance by contact with or ingestion of TPC by termites can disrupt their nervous system and lead to death.

TPC solution was tested for effectiveness against termites on Douglas Fir 2x4s exposed to an outdoor, termite infested, damp environment (wood pile) in Southern California for a period of over one year. Two 2x4s were given 2 coats of 50% (by weight) TPC solution in water on all 6 sides, with the wood allowed to dry between applications, and the two control 2x4s were untreated. After over one year, in the identical environment, adjacent to each other, the treated 2x4s did not exhibit signs of termite damage while the untreated 2x4s did have termite damage and fungal growth. The effectiveness of TPC applied to lumber for termite protection was demonstrated.

### BRIEF SUMMARY

Environmentally safe, water-based solutions of the alkali metal salt tripotassium citrate (TPC) that dry and form a crystalized coating have been developed and shown to be effective for the reduction and/or prevention of damage to wood and wood products from termites.

The novel process of protecting wood and wood products from termites, with environmentally safe, water-based solutions of the alkali metal salt tripotassium citrate (TPC) by one or more surface applications or by incorporation during manufacturing of engineered wood products has been developed, tested, and shown to be effective.

### DETAILED DESCRIPTION OF THE INVENTION

Environmentally safe, water-based solutions of the alkali metal salt tripotassium citrate (TPC) that dry and form a crystalized coating have been developed and shown to be effective for the reduction and/or prevention of damage to wood and wood products from termites.

The novel process of protecting wood and wood products from termites, with environmentally safe, water-based solutions of the alkali metal salt tripotassium citrate (TPC) by one or more surface applications or by incorporation during manufacturing of engineered wood products has been developed, tested, and shown to be effective.

Claim 1 is environmentally safe, termiticidal, water based chemical solutions of the alkali metal salt tripotassium citrate (TPC), preferably (but not limited to) 30-60% by weight, that dry and form termiticidal crystals and crystal complexes for the protection for wood and wood products from termites. The chemical solutions in Claim 1, modified such that termiticidal boron compounds such as boric acid or borax are added to achieve an approximately 1-3% final concentration of boron are claimed. The chemical solutions in Claim 1, modified such that surfactants such as triethyl citrate or sophorolipids are added to achieve a 0.1-2% final concentration are claimed. The chemical solutions in Claim 1, modified such that one or more environmentally safe, permanent, or long-lasting colorants, such as but not limited to natural seaweed dyes, are added such that the treated termite protected wood is readily identifiable are claimed. The chemical solutions in Claim 1, modified such that silicone containing compounds, typically in a 1-5% concentration, preferably in the form of silicone micelles, are added for their surfactant and water repellant effects, and to extend the duration of action and longevity of the TPC treatment are claimed. These Micelles are formed in a concentration above the Critical Micelle Concentration (CMC), which is the minimum concentration needed to reduce water surface tension and which is dependent on temperature, pH and the presence and concentration of other substances in solution are claimed.

Claim 6 is the process of protecting unpainted or unsealed wood and wood products from termite damage by the application or incorporation of the alkali metal salt tripotassium citrate (TPC) to or into the wood or wood products as a termiticidal aqueous solution preferably (but not limited to) 30-60% TPC concentration by weight. The process in Claim 6, whereby the TPC solution is applied to the unpainted or unsealed wood or wood products, such as but not limited to plywood, or oriented strand board, particle board, windows, doors, moldings, trim, and furniture, by brush, roller, dip, sprayer, vacuum or pressure treatment or other method either at the time of manufacture or post manufacturing is claimed. The process in Claim 6, whereby the TPC solution is applied to or incorporated into engineered wood products, such as but not limited to GLULAM, plywood, oriented strand board, particle board, engineered flooring, and laminated flooring, by application to or incorporation into the furnished product, an intermediate product, or their individual components in a wet state or after drying at the time of manufacture is claimed. The process in Claim 6 whereby the TPC aqueous solution is combined with other anti-termite compounds such as boron containing compounds (such as boric acid or borates such that typically the boron concentration is in the range of 1-3% in the final concentration) or with, surfactants and spreaders (such as but not limited to triethyl citrate or sophorolipids to achieve a 0.1-2% final concentration), or binders and adhesives (such as but not limited to xanthan gum, locust bean gum, guar gum, or other gums) is claimed. The process in Claim 6, whereby the TPC solution is applied to all six sides of cut wood or wood products post-manufacture at the assembly site or the construction site is claimed. The process in Claim 6, whereby after the TPC solution is applied and the wood or wood product has dried that a waterproofing or sealant treatment is applied (such as but not limited to atomized food grade silicone) is claimed. The process in Claim 6, whereby the TPC solution is preferably applied to rough sawn or rough cut lumber, which is typically less expensive, or alternatively to finished lumber that has been rough sanded, to allow the increased surface area to absorb more of the solution so that when it dries it will create more alkali metal salt crystals and crystal complexes on or near the surface to protect it from termite or other damage is claimed. The process in Claim 6, whereby the TPC solution that is applied contains an environmentally safe, permanent or long-lasting colorant, such as but not limited to natural seaweed dyes, to enable the treated wood to be easily identified is claimed. The process in Claim 6, whereby the TPC solution that is applied includes silicone containing compounds, preferably in the form of silicone micelles, to enhance the durability and longevity of the treatment and for their surfactant and water repellant effects, prepared in a concentration above the Critical Micelle Concentration for that particular solution is claimed.

1. Environmentally safe, termiticidal, water based chemical solutions of the alkali metal salt tripotassium citrate (TPC), preferably (but not limited to) 30-60% by weight, that dry and form termiticidal crystals and crystal complexes for the protection for wood and wood products from termites.

2. The chemical solutions in claim 1, modified such that termiticidal boron compounds such as boric acid or borax are added to achieve an approximately 1-3% final concentration of boron.

3. The chemical solutions in claim 1, modified such that surfactants such as triethyl citrate or sophorolipids are added to achieve a 0.1-2% final concentration.

4. The chemical solutions in claim 1, modified such that one or more environmentally safe, permanent, or long-lasting colorants, such as but not limited to natural seaweed dyes, are added such that the treated termite protected wood is readily identifiable.

5. The chemical solutions in claim 1, modified such that silicone containing compounds, typically in a 1-5% concentration, preferably in the form of silicone micelles, are added for their surfactant and water repellant effects, and to extend the duration of action and longevity of the TPC treatment. These Micelles are formed in a concentration above the Critical Micelle Concentration (CMC), which is the minimum concentration needed to reduce water surface tension and which is dependent on temperature, pH and the presence and concentration of other substances in solution.

6. The process of protecting unpainted or unsealed wood and wood products from termite damage by the application or incorporation of the alkali metal salt tripotassium citrate (TPC) to or into the wood or wood products as a termiticidal aqueous solution preferably (but not limited to) 30-60% TPC concentration by weight.

7. The process in claim 6, whereby the TPC solution is applied to the unpainted or unsealed wood or wood products, such as but not limited to plywood, or oriented strand board, particle board, windows, doors, moldings, trim, and furniture, by brush, roller, dip, sprayer, vacuum or pressure treatment or other method either at the time of manufacture or post manufacturing.

8. The process in claim 6, whereby the TPC solution is applied to or incorporated into engineered wood products, such as but not limited to GLULAM, plywood, oriented strand board, particle board, engineered flooring, and laminated flooring, by application to or incorporation into the furnished product, an intermediate product, or their individual components in a wet state or after drying at the time of manufacture.

9. The process in claim 6 whereby the TPC aqueous solution is combined with other anti-termite compounds such as boron containing compounds (such as boric acid or borates such that typically the boron concentration is in the range of 1-3% in the final concentration) or with, surfactants and spreaders (such as but not limited to triethyl citrate or sophorolipids to achieve a 0.1-2% final concentration), or binders and adhesives (such as but not limited to xanthan gum, locust bean gum, guar gum, or other gums).

10. The process in claim 6, whereby the TPC solution is applied to all six sides of cut wood or wood products post-manufacture at the assembly site or the construction site.

11. The process in claim 6, whereby after the TPC solution is applied and the wood or wood product has dried that a waterproofing or sealant treatment is applied (such as but not limited to atomized food grade silicone).

12. The process in claim 6, whereby the TPC solution is preferably applied to rough sawn or rough cut lumber, which is typically less expensive, or alternatively to finished lumber that has been rough sanded, to allow the increased surface area to absorb more of the solution so that when it dries it will create more alkali metal salt crystals and crystal complexes on or near the surface to protect it from termite or other damage.

13. The process in claim 6, whereby the TPC solution that is applied contains an environmentally safe, permanent or long lasting colorant, such as but not limited to natural seaweed dyes, to enable the treated wood to be easily identified.

14. The process in claim 6, whereby the TPC solution that is applied includes silicone containing compounds, preferably in the form of silicone micelles, to enhance the durability and longevity of the treatment and for their surfactant and water repellant effects, prepared in a concentration above the Critical Micelle Concentration for that particular solution.
